(19) United States
(12) Patent Application Publication
(10) Pub. No.: US 2015/0077047 A1
(43) Pub. Date: Mar. 19, 2015

(54) REAR CASE FOR WIRELESS CHARGING APPLICATION

(71) Applicant: JESS-LINK PRODUCTS CO., LTD., New Taipei City (TW)

(72) Inventor: Ta-Lum CHEN, New Taipei City (TW)

(73) Assignee: JESS-LINK PRODUCTS CO., LTD., New Taipei City (TW)

(21) Appl. No.: 14/091,419

(22) Filed: Nov. 27, 2013

(30) Foreign Application Priority Data
Sep. 17, 2013 (TW) 102217509

(51) Int. Cl. H02J 7/02

(52) U.S. Cl. CPC H02J 7/025
USPC 320/108

(57) ABSTRACT

The present invention is related to a rear case for wireless charging application (10) including a metal housing (100) and an induction coil (210). The metal housing (100) has an external surface (110) and an internal surface (120) opposite to the external surface (110). A containing chamber (111) is opened on the external surface (110). The containing chamber (111) is communicating with the external surface (110) and the internal surface (120). The induction coil (210) is set in the containing chamber (111). Thereby, the induction coil (210) is not shielded by the metal housing (100).

### BACKGROUND

1. Field of the Invention

The present invention is related to a rear case for wireless charging application, particularly a rear case used for wireless charging application and made of metal.

2. Description of Related Art

A conventional wireless charging module for mobile electronic device generally includes a circuit board and a coil. A chip is arranged on the circuit board, and the circuit board is electrically connected to the coil and a battery of the mobile device. A magnetic field is able to induce current in the coil via electromagnetic induction based on Faraday's law. The current induced by the magnetic field is supplied to the battery through the circuit board. The chip on the circuit board is used to control the current supply.

A conventional wireless charging apparatus has to be set on a plastic case of the mobile electronic device, because the magnetic field would be shielded by metal parts. However, insulation fixing structures are usually set on the housing of the conventional mobile electronic device. Therefore, the rear case of the conventional electronic device has to be made of metal, and the conventional wireless charging technology is not able to be applied to a metal rear case.

### SUMMARY

The purpose of the present invention is providing a rear case for wireless charging application, and the rear case is made of metal.

In order to make the above purpose, a rear case for wireless charging application including a metal housing and an induction coil is arranged in the present invention. The metal housing has an external surface and an internal surface opposite to the external surface. A containing chamber is defined on the external surface. The containing chamber is communicating with the external surface and the internal surface. The induction coil is set in the containing chamber. Thereby, the induction coil is not shielded by the metal housing.

A through hole communicating with the containing chamber and the internal surface is preferably defined on the metal housing, and the induction coil is exposed on the internal surface through the through hole.

The rear case for wireless charging application is preferably further included of a circuit board, and the induction coil being electrically connected to the circuit board.

A conductive electrode is preferably arranged on the circuit board, the conductive electrode is exposed on the internal surface, and the conductive electrode is electrically connected to the induction coil.

The circuit board is preferably arranged in the containing chamber.

The circuit board is preferably arranged on the internal surface of the metal housing.

The containing chamber is preferably extended from the external surface to the internal surface.

A conductive electrode is preferably arranged on the internal surface.

An insulation fixing structure encapsulating the induction coil is preferably arranged in the containing chamber.

A containing chamber is defined on the rear case for wireless charging application of the present invention, and the induction coil is arranged in the containing chamber. Therefore, the containing chamber would not be shielded by the metal housing and is able to be introduced by the magnetic field, and current is thereby generated in the induction coil.

### BRIEF DESCRIPTION OF DRAWING

FIG. 1 is an exploded diagram showing the first embodiment of the present invention;

FIG. 2 is a schematic view showing the first embodiment of the present invention;

FIG. 3 is another schematic view showing the first embodiment of the present invention;

FIG. 4 is a sectional view showing the first embodiment of the present invention;

FIG. 5 is a schematic view showing the wireless charging module in the first embodiment of the present invention;

FIG. 6 is a schematic view showing a usage of the present invention;

FIG. 7 is a schematic view showing another usage of the present invention;

FIG. 8 is a schematic view showing the second embodiment of the present invention;

FIG. 9 is a schematic view showing the third embodiment of the present invention;

FIG. 10 is a schematic view showing the forth embodiment of the present invention.

### DETAILED DESCRIPTION OF EMBODIMENT

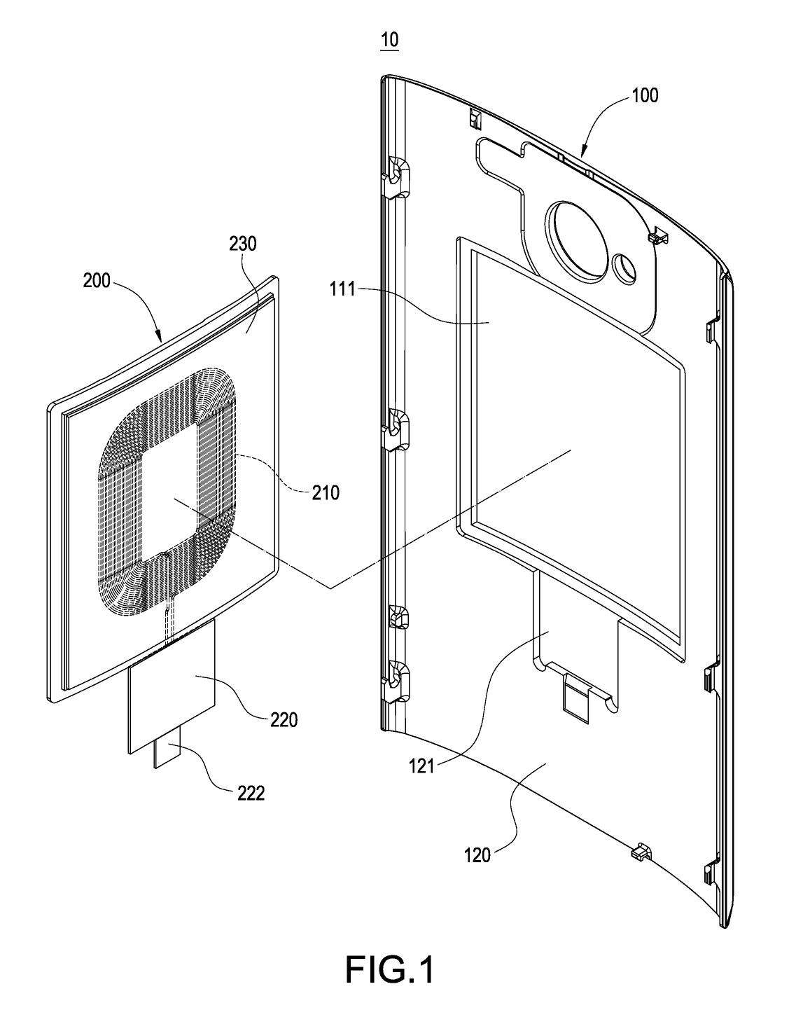

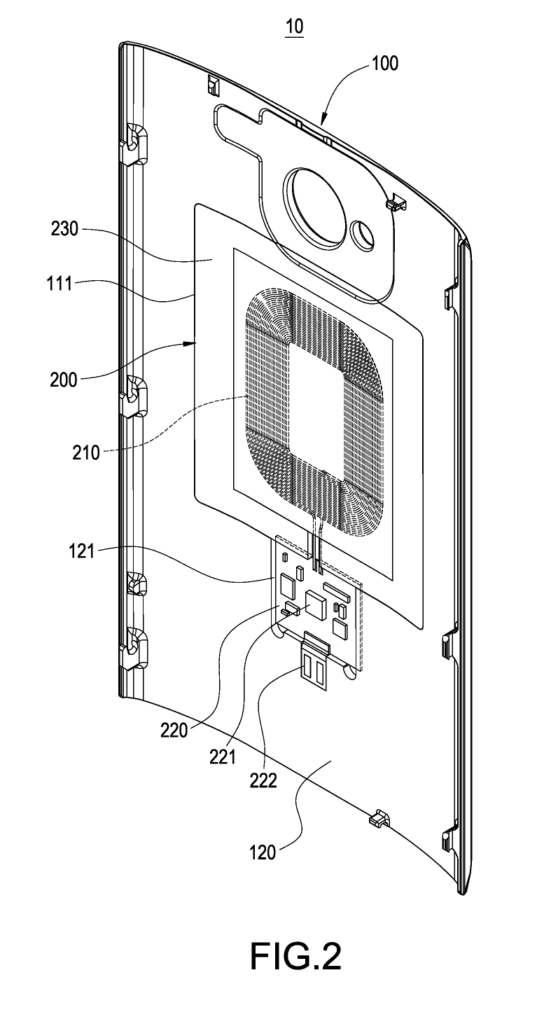

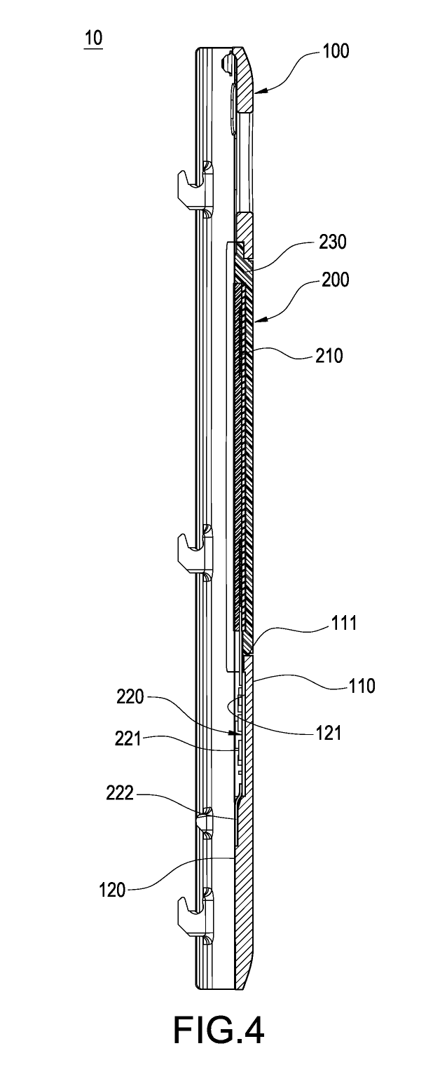

Please refer to FIG. 1 to FIG. 4. A rear case for wireless charging application (10) is provided in the first embodiment of the present invention. The rear case for wireless charging application (10) is including of a metal housing (100) and a wireless charging module (200) arranged on the metal housing (100).

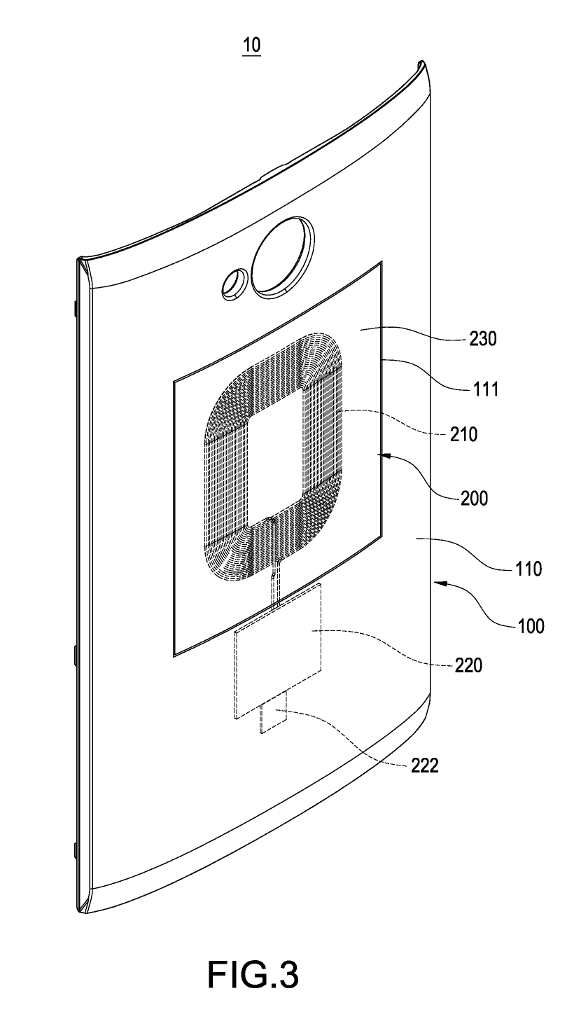

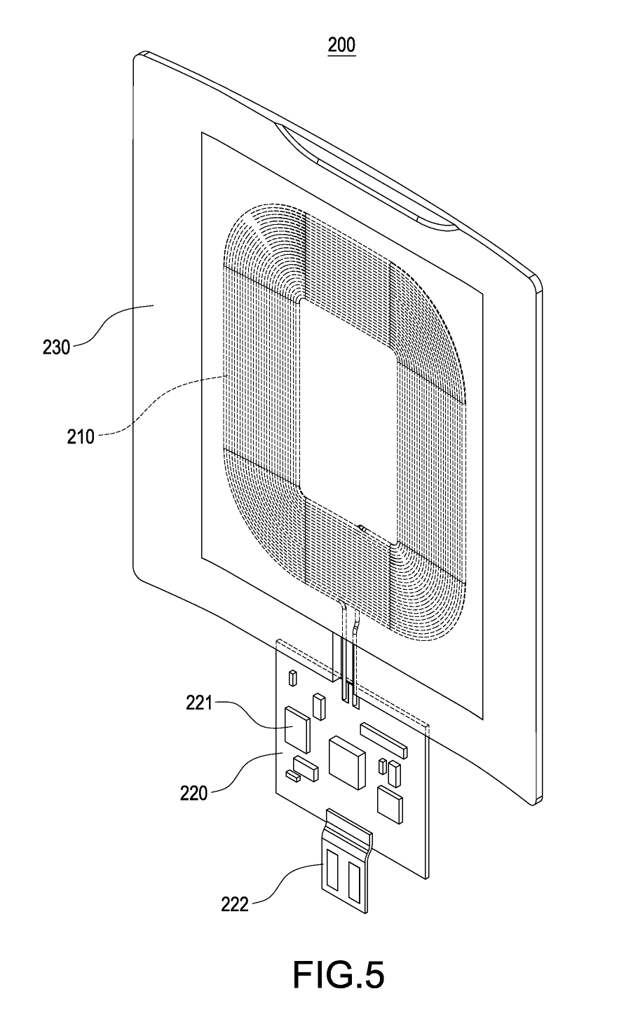

The metal housing (100) has an external surface (110) and an internal surface (120) opposite to the external surface (110). A containing chamber (111) is defined on the external surface (110), and a cavity (121) is defined on the internal surface (120). The containing chamber (111) communicates with the external surface (110) and the internal surface (120). In the present embodiment, the containing chamber (111) is preferably extended in metal housing (100) and from the external surface (110) to the internal surface (120). Please refer to FIG. 3 to FIG. 5. The wireless charging module (200) is including of an induction coil (210) and a circuit board (220), and the induction coil (210) is electrically connected to the circuit board (220). The circuit board (220) is arranged at the internal surface (120) of the metal housing (100). In the present invention, the circuit board (220) is preferably arranged in the cavity (121). A charging circuit (221) and a couple of conductive electrodes (222) are arranged on the circuit board (220). The conductive electrodes (222) are exposed on the internal surface (120) of the metal housing (100). The charging circuit (221) is electrically connected to the induction coil (210) and the conductive electrodes (222), and the conductive electrodes (222) are thereby electrically connected to the induction coil (210) via the charging circuit (221).

In the present embodiment, an insulation fixing structure (230) for fixing the induction coil (210) in the containing chamber (111) is arranged in the containing chamber (111). The insulation fixing structure (230) is preferably made of plastic or rubber, but this is not a limitation of the present invention. The induction coil (210) is embedded in the insulation fixing structure (230). The figure of the insulation fixing structure (230) is corresponded to the containing chamber (111), and the insulation fixing structure (230) is clamped in the containing chamber (111). Thereby, the induction coil (210) is fixed in the containing chamber (111).

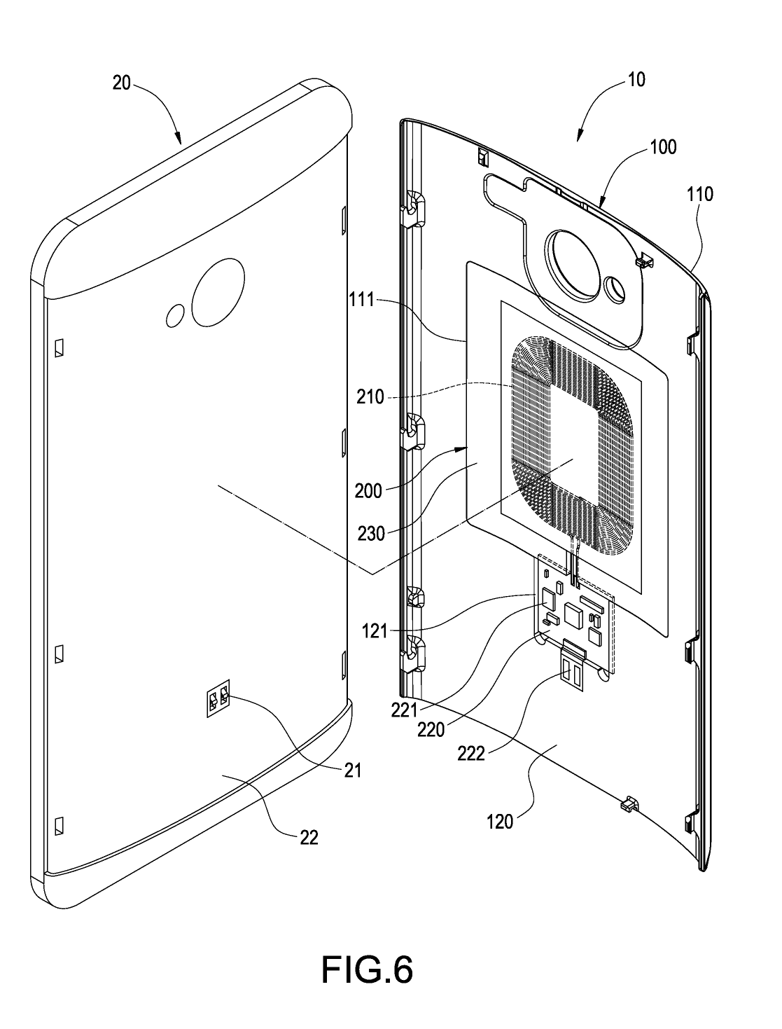

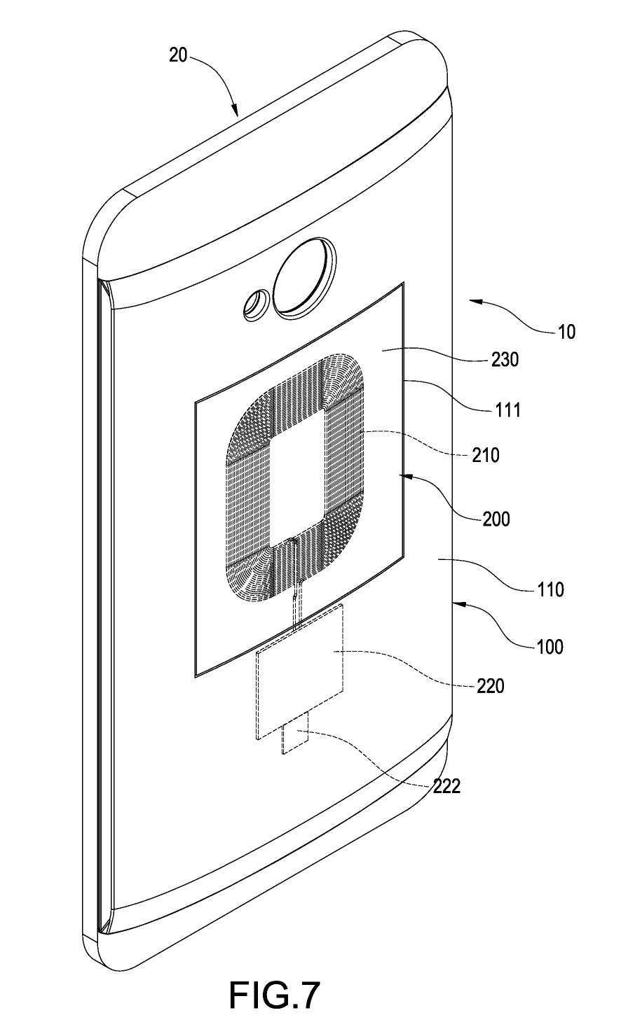

Please refer to FIG. 6 and FIG. 7. In the present embodiment, the rear case for wireless charging application (10) of the present invention is applied to an electronic device. The electronic device is included of a main body (20) and a battery (not shown in figures) is arranged in the main body (20). A couple of conductive terminals (21) electrically connected to the battery are arranged on the main body (20). The main body (20) is covered by the rear case (10) of the present invention. The internal surface (120) of the metal housing (100) is attached on the main body (20), and the conductive electrodes (222) are electrically connected to the conductive terminals (21). Thereby, the induction coil (210) is electrically connected to the battery, and the current generated in the induction coil (210) could be supplied to the battery via the charging circuit (221).

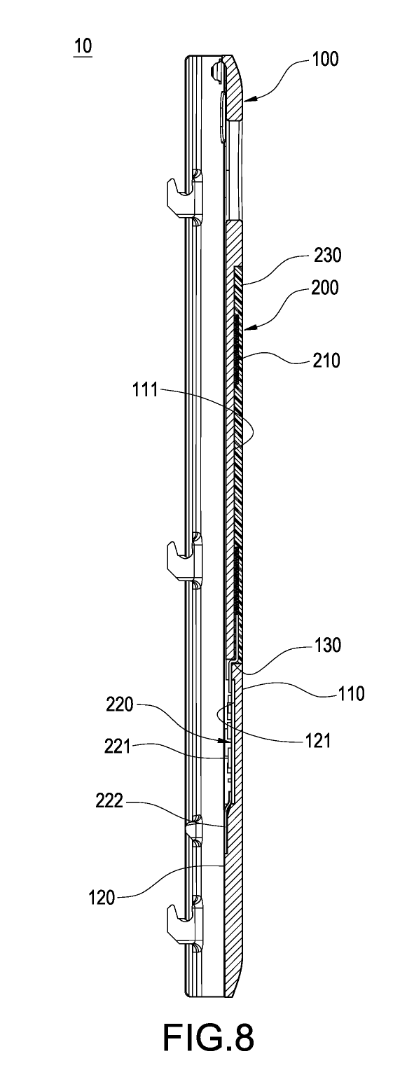

Please refer to FIG. 8. A rear case for wireless charging application (10) is provided in the second embodiment of the present invention. The rear case for wireless charging application (10) is including of a metal housing (100) and a wireless charging module (200) arranged on the metal housing (100).

The metal housing (100) has an external surface (110) and an external surface (120) opposite to the internal surface (110). A containing chamber (111) is defined on the external surface (110), and a cavity (121) is defined on the internal surface (120). The containing chamber (111) communicates with the external surface (110) and the internal surface (120). In the present embodiment, a through hole (130) is defined on the metal housing (100), and the through hole (130) communicates with the containing chamber (111) and the internal surface (120) of the metal housing (100).

The wireless charging module (200) is included of an induction coil (210) and a circuit board (220). The induction coil (210) is arranged in the containing chamber (111) of the metal housing (100), the induction coil (210) is exposed on the internal surface (120) through the through hole (130), and the induction coil (210) is thereby electrically connected to the circuit board (220). The circuit board (220) is arranged on the internal surface (120) of the metal housing (100). In the present embodiment, the circuit board (220) is arranged in the cavity (121). A charging circuit (221) and a couple of conductive electrodes (222) are arranged on the circuit board (220). The conductive electrodes (222) are exposed on the internal surface (120) of the metal housing (100). The charging circuit (221) is electrically connected to the induction coil (210) and the conductive electrodes (222), and the conductive electrodes (222) are thereby electrically connected to the induction coil (210) via the charging circuit (221).

In the present embodiment, an insulation fixing structure (230) for fixing the induction coil (210) in the containing chamber (111) is arranged in the containing chamber (111). The insulation fixing structure (230) is described in the first embodiment, and will not be discussed in the paragraphs below. As the first embodiment mentioned, the rear case for wireless charging application (10) of the present invention is applied to an electronic device.

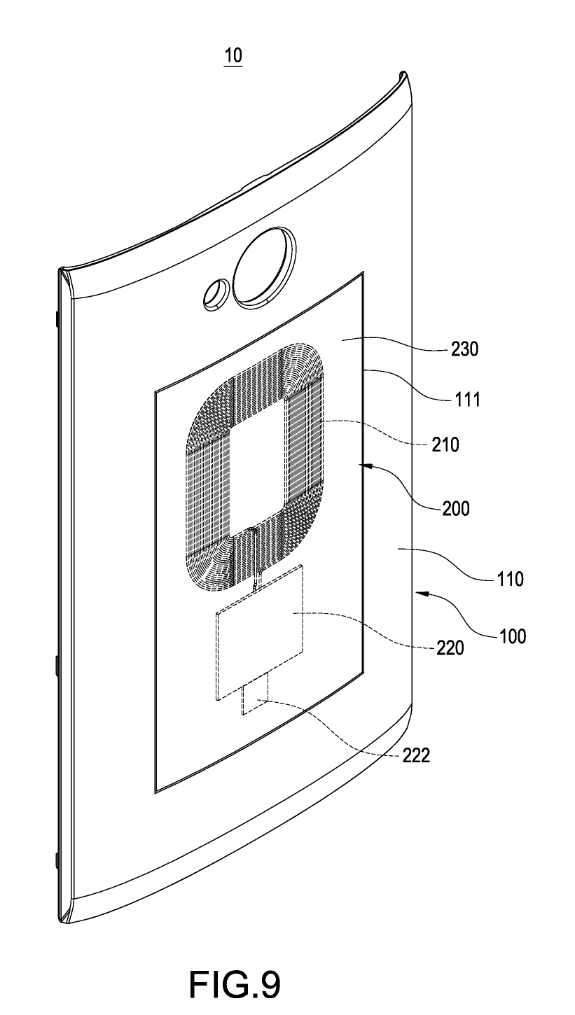

Please refer to FIG. 9. A rear case for wireless charging application (10) is provided in the third embodiment of the present invention. The rear case for wireless charging application (10) is including of a metal housing (100) and a wireless charging module (200) arranged on the metal housing (100).

The metal housing (100) has an external surface (110) and an internal surface (120) opposite to the external surface (110). A containing chamber (111) is defined on the external surface (110), and the containing chamber communicates with the external surface (110) and the internal surface (120). In the present embodiment, the containing chamber is preferably extended from the external surface (110) to the internal surface (120) through the metal housing (100).

The wireless charging module (200) is included of an induction coil (210) and a circuit board (220). The induction coil (210) and the circuit board (220) are both arranged in the containing chamber (111), and the induction coil (210) is electrically connected to the circuit board (220). A charging circuit (221) and a couple of conductive electrodes (222) are arranged on the circuit board (220), the conductive electrodes (222) are exposed on the internal surface (120) of the metal housing (100), the charging circuit (221) is electrically connected to the induction coil (210) and the conductive electrodes (222), and the conductive electrodes (222) are thereby electrically connected to the induction coil (210) via the charging circuit (221).

In the present embodiment, an insulation fixing structure (230) for fixing the induction coil (210) in the containing chamber (111) is arranged in the containing chamber (111). The insulation fixing structure (230) is preferably made of plastic or rubber, but this is not a limitation of the present invention. The induction coil (210) and the circuit board (220) are both embedded in the insulation fixing structure (230). The figure of the insulation fixing structure (230) is corresponded to the containing chamber (111), and the insulation fixing structure (230) is clamped in the containing chamber (111). Thereby, the induction coil (210) and the circuit board (220) are fixed in the containing chamber (111).

As the first embodiment mentioned, the rear case for wireless charging application (10) of the present invention is applied to an electronic device.

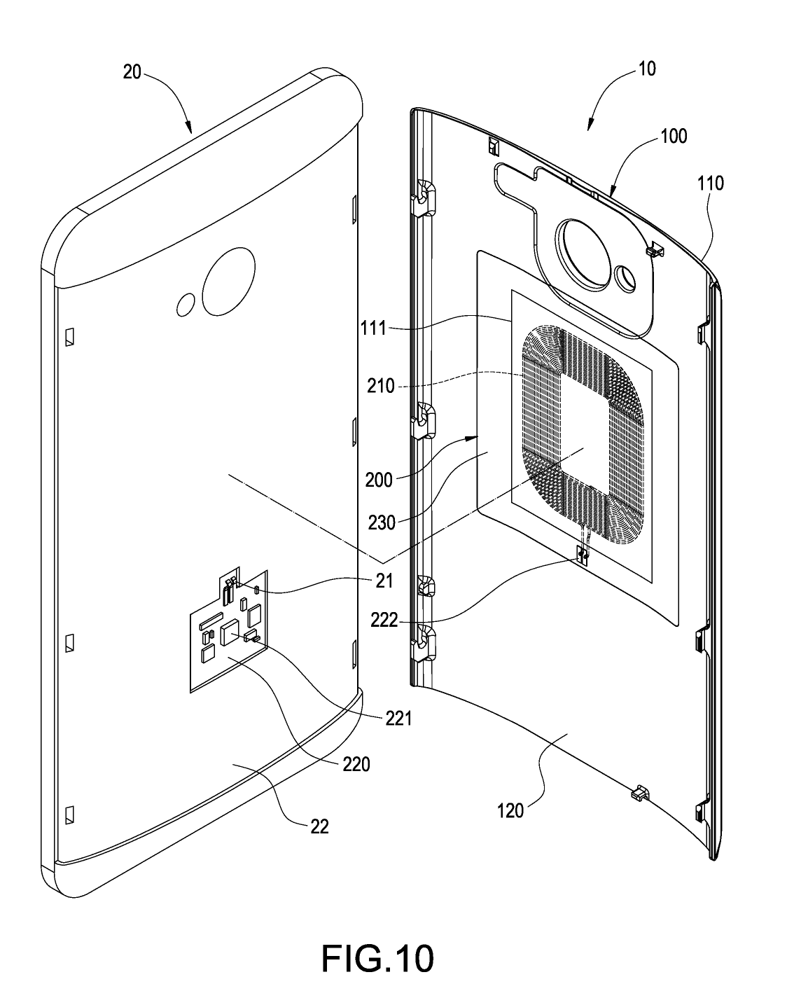

Please refer to FIG. 10. A rear case for wireless charging application (10) is provided in the fourth embodiment of the present invention. The rear case (10) is applied to an electronic device. The electronic device is included of a main body (20), a circuit board (220) is arranged on the main body (20), a couple of conductive terminals (21) are arranged on the circuit board (220), and the conductive terminals (21) are exposed on a back surface (22) of the main body (20).

The back surface (22) of the main body (20) is covered by the rear case (10). The rear case (10) is included of a metal housing (100) and an induction coil (210). The metal housing (100) has an external surface (110) and an internal surface (120) opposite to the external surface (110). A containing chamber (111) is opened on the external surface (110), and the containing chamber (111) is communicating with the external surface (110) and the internal surface (120). The internal surface (120) is attached on the back surface (22) of the main body (20). The induction coil (210) is arranged in the containing chamber (111), and a couple of conductive electrodes (222) for electrically connecting to the conductive terminals (21) are arranged in the containing chamber (111). The conductive electrodes (222) are exposed on the internal surface (120) of the metal housing (100), and the induction coil (210) is electrically connected to the conductive electrodes (222).

In the present embodiment, an insulation fixing structure (230) for fixing the induction coil (210) and the conductive electrodes (222) in the containing chamber (111) is arranged in the containing chamber (111). The insulation fixing structure (230) is preferably made of plastic or rubber, but this is not a limitation of the present invention. The induction coil (210) and the conductive electrodes (222) are both embedded in the insulation fixing structure (230), the figure of the insulation fixing structure (230) is corresponded to the containing chamber (111), and the insulation fixing structure (230) is clamped in the containing chamber (111). Thereby, the induction coil (210) and the conductive electrodes (222) are fixed in the containing chamber (111).

A containing chamber (111) for containing the induction coil (210) is opened on the external surface (110) of rear case for wireless charging application (10) in the present invention. Therefore, the conductive coil (210) would not shielded by the metal housing (100) and is able to be introduced by a magnetic field, current is thereby generated in the induction coil and supplied to the battery in the electronic device.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A rear case for wireless charging application (10) comprising:
a metal housing (100) comprising an external surface (110) and an internal surface (120) opposite to the external surface (110), a containing chamber (111) defined on the external surface (110), the containing chamber (111) communicating with the external surface (110) and the internal surface (120); and
an induction coil (210) arranged in the containing chamber (111).

2. The rear case for wireless charging application (10) according to claim 1, wherein a through (130) communicating with the containing chamber (111) and the internal surface (120) is defined on the metal housing (100), the induction coil (210) is exposed on the internal surface (120) through the through hole (130).

3. The rear case for wireless charging application (10) according to claim 1, further comprising a circuit board (220), and the induction coil (210) being electrically connected to the circuit board (220).

4. The rear case for wireless charging application (10) according to claim 3, wherein a conductive electrode (222) is arranged on the circuit board (220), the conductive electrode (222) is exposed on the internal surface (120), and the conductive electrode (222) is electrically connected to the induction coil (210).

5. The rear case for wireless charging application (10) according to claim 3, wherein the circuit board (220) is arranged in the containing chamber (111).

6. The rear case for wireless charging application (10) according to claim 3, wherein the circuit board (220) is arranged on the internal surface (120) of the metal housing (100).

7. The rear case for wireless charging application (10) according to claim 1, wherein the containing chamber (111) is extended from the external surface (110) to the internal surface (120).

8. The rear case for wireless charging application (10) according to claim 1, wherein a conductive electrode (222) is arranged on the internal surface (120).

9. The rear case for wireless charging application (10) according to claim 1, wherein an insulation fixing structure (230) encapsulating the induction coil (210) is arranged in the containing chamber (111).
